(19) United States
(12) Patent Application Publication
(10) Pub. No.: US 2006/0277099 A1
(43) Pub. Date: Dec. 7, 2006

(54) Systems, methods and apparatuses employing electronic gamepieces used in a sweepstakes or drawing

(75) Inventors: Alice Harlow Ronconi, Henderson, NV (US); Edith Mercedes Navia, Atlanta, GA (US)

Correspondence Address: SUTHERLAND ASBILL & BRENNAN LLP, 999 PEACHTREE STREET, N.E., ATLANTA, GA, 30309, US

(73) Assignee: The Coca-Cola Company

(21) Appl. No.: 11/388,423

(22) Filed: Mar. 24, 2006

Related U.S. Application Data
(60) Provisional application No. 60/686,584, filed on Jun. 1, 2005.
(60) Provisional application No. 60/754,165, filed on Dec. 27, 2005.

(51) Int. Cl. G06Q 30/00

(52) U.S. Cl. 705/14

(57) ABSTRACT

An electronic gamepiece alerts a consumer that the consumer is a winner after a certain period of time has passed after the consumer takes possession of the gamepiece. Because the alert is only active for a period of time, the consumer must turn in the winning gamepiece within that period of time to redeem an award or receive a prize. Winning gamepieces may be intermingled with visibly similar devices that are inactive and do not light up. Thus, a large volume of gamepieces may be handed out in a sweepstakes to entice consumers to stay geographically a the location at which a winning gamepiece is to be redeemed. Wireless gamepieces may also be selected at random to receive wireless alerts after the passing of a period of time.

### RELATED APPLICATION DATA

The present application claims priority to U.S. Provisional Application Ser. No. 60/686,584, filed on Jun. 1, 2005, titled “Electronic Gamepiece For Use In A Sweepstakes Or Drawing”, and U.S. Provisional Application Ser. No. 60/754,165, filed on Dec. 27, 2005, titled “Systems, Methods and Apparatuses Employing Electronic Gamepieces Used in a Sweepstakes or Drawing”. The entire contents of both provisional applications are incorporated herein by reference as if set forth fully herein.

### FIELD OF THE INVENTION

The present invention relates generally to gamepieces, and more particularly, to devices used as gamepieces in a sweepstakes or drawing, and systems for implementing the same.

### BACKGROUND OF THE INVENTION

Conventional gamepieces offer consumers an instant result so that a consumer immediately knows whether the consumer has won or lost a drawing or sweepstakes. An example of such an item is an instant lottery game that allows a consumer to scratch off a protective cover to reveal whether the gamepiece is a winning or losing piece. Such devices fail to keep consumers entangled in a sweepstakes for more than a short period of time. On the other hand, longer term sweepstakes or events, such as the lottery or drawing, typically have an extended period of time between the receipt of a gamepiece or receipt and a drawing to determine the winner or winners of the lottery or drawing. As a result, these items also fail to keep a consumer entangled in a location in which the sweepstakes or drawing is taking place.

What is therefore needed is a device to keep a consumer “entangled” longer in a location where a sweepstakes or drawing is being conducted. This would allow a sponsor of the game or drawing to keep consumers on premises longer, which in turn may lead to increased sales of the products or services the sponsor offers.

### SUMMARY OF THE INVENTION

According to an embodiment of the invention, there is disclosed a device, intended for use as a gamepiece in a sweepstakes or drawing, that does not immediately reveal if a consumer is a winner. Generally, the device contains electronic elements including a battery, timer and/or control circuit, and one or more alert mechanisms such as LEDs, a vibrating mechanism, a speaker, or the like. The device may be activated by a consumer via a pull tab that, upon removal, provides power to the device. If the device is a “winner,” it will begin to flash, vibrate, or emit an audible sound (an ‘alert’) after a pre-determined amount of time has passed, after which it may be turned in by a consumer to redeem a prize or to claim an award.

According to another embodiment of the invention, there is disclosed a device that may be carried by a consumer, or worn by a consumer (e.g., as a watch), which may receive promotional information wirelessly transmitted to the device. For instance, promotional information including the identification of sweepstakes winners may be broadcast to wireless gamepieces. The broadcast of promotional information may be limited in geographic range, such that consumers may be required to be within a sweepstakes area, such as a building, to receive the promotional information. According to one aspect of the invention, the wireless gamepieces may also receive other information outside of the range of the sweepstakes area.

According to an embodiment of the invention, a gamepiece of the present invention includes at least one alert mechanism operable to alert a person associated with the gamepiece, and a timing mechanism operable to activate the at least one alert mechanism after the passage of a predetermined length of time unknown to the person. According to one aspect of the invention, the gamepiece includes an initiator, operated by the person, which may be a carrier or holder of the gamepiece, and the initiator is operable to instruct the timing mechanism to begin operation to determine the passage of the predetermined length of time. According to another aspect, the initiator is operable to receive wireless activation to instruct the timing mechanism to begin operation to determine the passage of the predetermined length of time. According to yet another aspect of the invention, the at least one alert mechanism may be a light emitting diode (LED), a light, a vibrating mechanism, and/or a speaker.

The timing mechanism of the gamepiece may include a battery. According to another aspect, the gamepiece may include a battery separate from, but coupled to, the timing mechanism. Additionally, the at least one alert mechanism can be operable to alert a person associated with the gamepiece for a period of time, which may in turn be based at least in part on the power remaining in the battery.

According to another embodiment of the present invention, there is disclosed a method of alerting a person of a contest result. The method includes activating a timing mechanism of a gamepiece, where the timing mechanism is operable to activate at least one alert mechanism of the gamepiece after the passage of a predetermined length of time unknown to the person.

According to one aspect of the invention, the method also includes activating a battery of the gamepiece. According to another aspect of the invention, activating the timing mechanism comprises wirelessly activating the timing mechanism. Additionally, the timing can be operable to activate at least one alert mechanism selected from the group of alert mechanisms consisting of a light emitting diode (LED), a light, a vibrating mechanism, and a speaker.

According to yet another embodiment of the invention, a promotion system is disclosed. The system includes a plurality of wireless gamepieces, where at least some of the plurality of wireless gamepieces are registered devices. The system also includes software operable to randomly select at least one winning device from the plurality of registered wireless gamepieces, and at least one transmitter operable to transmit promotional information to the at least some of the plurality of wireless gamepieces, where the promotional information alerts a person associated with the at least one winning device that he or she has won an award or prize.

According to an aspect of the invention, the at least one transmitter is a radio frequency (RF) transmitter. The at least one transmitter may be an FM transmitter. The plurality of wireless gamepieces in the system may be a phone, watch, personal digital assistant, email device, smart card, RF device, or GPS receiver. According to another aspect of the invention, the at least one transmitter is operable to transmit the promotional information only over a short distance, such that the promotional information alerts the person that he or she has won an award or prize only if the person is within the short distance from the at least one transmitter.

According to yet another embodiment of the invention, there is disclosed a promotion system. The system includes a plurality of wireless gamepieces, where at least some of the plurality of wireless gamepieces are registered devices. The system further includes software operable to randomly select at least one winning device from the plurality of registered wireless gamepieces, and at least on transmitter operable to transmit promotional information to the at least one winning device to alert a person associated with the at least one winning device that he or she has won an award or prize.

According to an aspect of the invention, the at least one transmitter is a radio frequency (RF) transmitter. The at least one transmitter may be an FM transmitter. The plurality of wireless gamepieces in the system may be a phone, watch, personal digital assistant, email device, smart card, RF device, or GPS receiver. According to another aspect of the invention, the at least one transmitter is operable to transmit the promotional information only over a short distance, such that the promotional information alerts the person that he or she has won an award or prize only if the person is within the short distance from the at least one transmitter.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a perspective view of a gamepiece, according to an illustrative embodiment of the present invention.

FIG. 2 is a block diagram illustrating the components of a gamepiece, according to an illustrative embodiment of the present invention.

FIG. 3 is a block diagram flow chart illustrating a method of using a gamepiece of the present invention, according to an embodiment of the present invention.

FIG. 4 is a block diagram flow chart illustrating a method of using a gamepiece of the present invention, according to an embodiment of the present invention.

FIG. 5 shows an illustrative example of a system employing wireless gamepieces, according to an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Briefly, the present invention is directed to an electronic gamepiece that alerts a consumer that the consumer is a winner only after a certain period of time has passed after the consumer takes possession of the gamepiece. According to an embodiment of the invention, a gamepiece may be handed to a consumer, after which the consumer must retain the gamepiece until the gamepiece alerts the consumer that the consumer is a winner. The alert may be in the form of one or more flashing lights or light emitting diodes (LEDs) on the gamepiece, a vibrating mechanism, an audible sound, and/or a graphical display. Because the alert is only active for a period of time, the consumer must turn in the winning gamepiece or identify themselves as a winner of the contest or sweepstakes within that period of time to redeem an award or receive a prize. According to an aspect of the invention, winning gamepieces may be intermingled with visibly similar devices that are inactive and do not light up. Thus, a large volume of gamepieces may be handed out in a sweepstakes to entice consumers to stay geographically near the location at which a winning gamepiece is to be redeemed. According to another embodiment of the invention, gamepiece alerts may be transmitted wirelessly to gamepieces, where a consumer has a limited amount of time to identify themselves as a winner of the sweepstakes or contest.

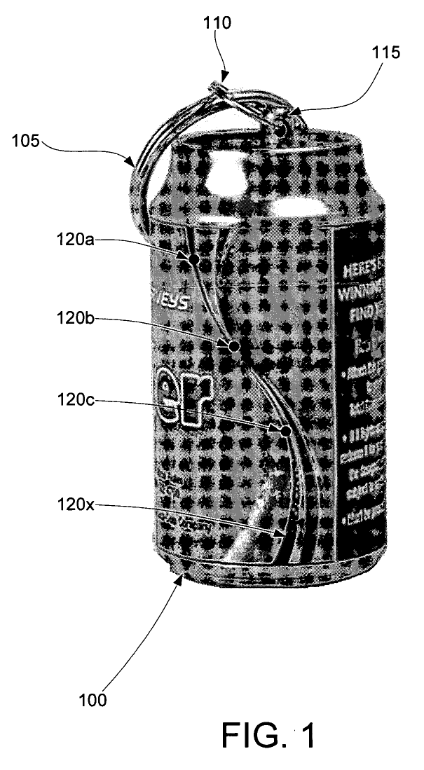

Referring now to FIG. 1, a perspective view of a gamepiece 100 according to an illustrative embodiment of the present invention is shown. As shown in FIG. 1, the gamepiece 100 is generally in the shape of an aluminum can, e.g., the shape of a 12 oz aluminum soft drink. The gamepiece 100 includes a pull tab 105 that is operatively connected to a pin 115 that protrudes through the top of the gamepiece 100. The gamepiece 100 also includes at least one connector piece 110 for connecting the pull tab 105 to pin 115, though it will be appreciated that the pull tab 105 may also be connected directly to the pin 115 such that the connector piece 110 is unnecessary. The gamepiece 100 further comprises one or more light emitting diodes (LEDs) 120a, 120b, 120c, . . . , 120x. It will be appreciated that although the present invention is described with respect to a gamepiece 100 having LEDs 120a, 120b, 120c, . . . , 120x, that the gamepiece may additionally or alternatively include an alert (or alert mechanism) such as vibrating mechanism, speaker for emitting an audible sound, and/or a graphical display to alert a consumer. Therefore, while the gamepiece 100 of FIG. 1 is described herein with respect to alerts using only lights, the present invention is not intended to be limited to lights as the sole alert mechanism.

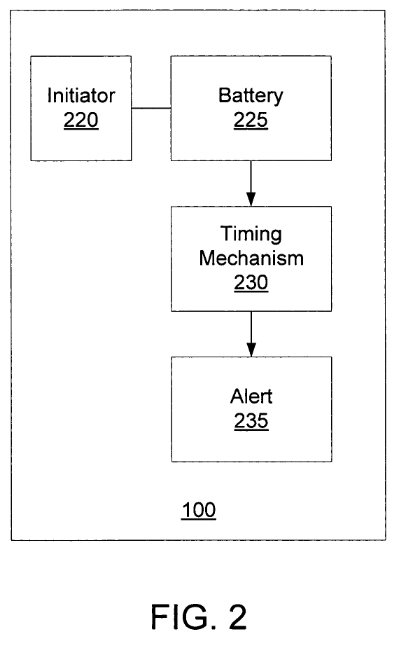

As described in detail with respect to FIG. 2, while inserted the pin 115 prevents an internal battery of the gamepiece 100 from operating. Thus, while the pin 115 remains inserted in the gamepiece 100 the internal battery is inactive and the gamepiece 100 does not operate. A consumer may remove the pin 115 using the pull tab 105 to activate the internal battery. Once the internal battery is activated, it provides power to a pre-programmed timing mechanism that begins to operate. After the timing mechanism has reached its designated pre-programmed interval, the gamepiece 100 may power the one or more LEDs 120a, 120b, 120c, . . . , 120x. According to one aspect of the invention, after the timing mechanism within the gamepiece 100 has reached its designated pre-programmed interval, the one or more LEDs 120a, 120b, 120c, . . . , 120x may flash.

According to one aspect of the invention, the one or more LEDs 120a, 120b, 120c, . . . , 120x may flash for a predetermined period of time. According to another aspect of the invention, the one or more LEDs 120a, 120b, 120c, . . . , 120x may flash until the internal battery of the gamepiece 100 is depleted. As described above, a winning consumer in possession of a gamepiece 100 having lit or flashing LEDs 120a, 120b, 120c, . . . , 120x may be required to turn in the gamepiece 100 for an award or prize while the LEDs 120a, 120b, 120c, . . . , 120x remain lit or flashing. This serves to encourage the consumer from straying from or leaving a sweepstakes area, else the consumers may be unable to timely claim a prize or an award.

Although the gamepiece 100 illustrated in FIG. 1 is illustrated generally in the shape of an aluminum can, it will be appreciated that gamepieces according to the present invention may take any form capable of retaining a power source and the electronics to activate an alert mechanism (e.g., one or more lights, LEDs, vibrating mechanisms, speakers, displays, and/or the like) after the passing of a period of time. Because electronics may be constructed out of small components, and because the battery in the gamepiece only has to be active for a relatively short period of time, small gamepieces may be constructed. For instance, a gamepiece according to the present invention may take the form of a relatively thin card, such as the size of a smart card or credit card. Therefore, it will be appreciated by those of ordinary skill in the art that the form in which the gamepiece is embodied may be insignificant to the operation of the present invention.

FIG. 2 shows a block diagram illustrating the components of the gamepiece 100 of FIG. 1, according to an illustrative embodiment of the present invention. Specifically, the gamepiece 100 generally includes an initiator 220, battery 225, timing mechanism 230, and alert mechanism 235. Although illustrated in FIG. 2 as entirely internal to the gamepiece 100, the initiator 220 may comprise one or more elements internal and/or external to the gamepiece 100 for activating the battery 225. For instance, the initiator 220 may comprise the pull tab 105, connector piece 110 and pin 115 in the embodiment illustrated in FIG. 1.

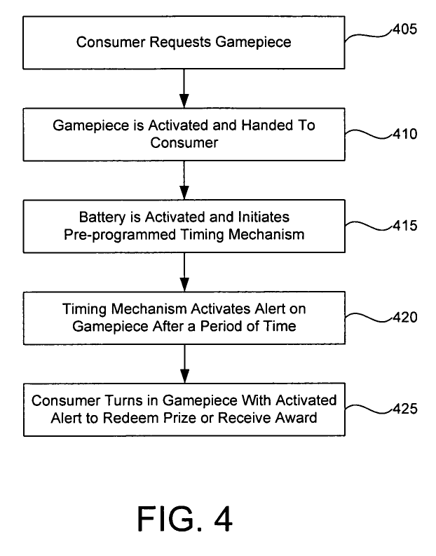

In the embodiment of FIG. 1, the initiator 220 is operated by a consumer upon receipt of the gamepiece 100, where the consumer pulls the pull tab 105 to activate the battery 225. As described with respect to FIG. 4, it will be appreciated that the initiator 220 may be also be substantially or entirely internal to the gamepiece 100 and activated electronically. For instance, the initiator 220 may be activated using one or more wireless activation signals provided by an operator of a sweepstakes, or via one or more electrical signals passed to the gamepiece 100 via one or more electrical leads coupled to or forming the initiator 220. Thus, it will be appreciated that the primary purpose of the initiator 200—to activate the battery 225—may be implemented using a variety of devices in the control of a consumer and/or a sweepstakes operator.

Referring again to FIG. 2, the initiator 220 is coupled to a battery 225 for powering the timing mechanism 230 and alert mechanism 235, which may include one or more lights, vibrating mechanisms, speakers, LEDs or the like. Because the battery 225 is activated by the initiator 220, a battery 225 having a relatively small charge may be used. Additionally, because LEDs require a small amount of power for their operation, a battery 225 providing relatively small power levels may be used. Almost any type of battery 225 known to those of ordinary skill in the art may be positioned internal to the gamepiece 100.

Upon its activation by the initiator, the battery 225 provides power to the pre-programmed timing mechanism 230. According to an aspect of the invention, the timing mechanism 230 begins to operate immediately after receiving power from the battery 225. The timing mechanism 230 may include a pre-programmed interval of time, upon the expiration of which the timing mechanism permits the activation of the alert mechanism 235. According to an aspect of the invention, the pre-programmed interval of time may be set before the timing mechanism 230 is placed in the gamepiece 100. According to an alternative aspect of the invention, the timing mechanism 230 may be wirelessly or remotely programmed after its insertion into the gamepiece 100, although such a construction may encourage consumers to tamper with the gamepiece 100 in an attempt to reprogram the interval of time set by the timing mechanism 230.

The timing mechanism 230 may comprise hardware, software, or a combination thereof. After the timing mechanism 230 has reached its designated pre-programmed interval, the gamepiece 100 may power the alert mechanism 235, e.g., the one or more LEDs 120a, 120b, 120c, . . . , 120x. The timing mechanism 230 may also include circuitry for controlling the alert mechanism 235, such as controlling the blinking or flashing of one or more LEDs 120a, 120b, 120c, . . . , 120x, the playing of one or more sounds, the vibrating of the device, the presentation of graphics on a display, or the like. According to another embodiment, the alert mechanism 235 may be controlled by another mechanism and/or component within the gamepiece 100, as will be appreciated by those of ordinary skill in the art.

Although the timing mechanism 230 has been described herein as powering the alert mechanism 235 after a pre-programmed length of time, it will be appreciated that the timing mechanism may use alternative timing methods. For instance, the timing mechanism may employ a random time generator such that the amount of time that passes prior to the powering of the display may vary and may be unpredictable. Additionally, according to another embodiment, the timing mechanism may base the powering of the alert mechanism at least in part on information provided by other elements within the gamepiece 100.

For instance, a gamepiece according to the present invention can include a GPS receiver or transceiver (not illustrated) that allows the gamepiece to identify its location. The timing mechanism may work in conjunction with the GPS transceiver such that the timing mechanism alters the amount of time that passes prior to the powering of the display based on the location of the gamepiece. Additionally, although the initiator is described in the illustrative examples over as being controlled by a consumer or a sweepstakes operator, the activation of the battery 225, and thus the initiation of the timing mechanism 230, may also be based on the location of the gamepiece as identified by a GPS receiver or transceiver.

According to one aspect of the invention, different gamepieces may be constructed with varying odds of winning. As an example, a sweepstakes promoter may wish to provide gamepieces to highly valued consumers that include an increased odds of winning, while other consumers receive gamepieces with reduced odds. The gamepieces with varying odds may be constructed to look the same or different. According to one method, a consumer that successfully completes a task requested by a sweepstakes promoter may turn in a gamepiece for a gamepiece having increased odds at winning.

According to another embodiment of the invention, the gamepiece 100 may include hardware operable to communicate with active or passive RF tags, which are known in the art. This may permit the initiator 220 and/or timing mechanism 230 on the gamepiece to activate after the gamepiece 100 has come within the vicinity of an RF tag or similar device operable to transmit to, or receive information from, the gamepiece 100. For instance, multiple RF tags may be placed within a sweepstakes area such that a consumer within the range of such a device may unknowingly activate the initiator 220 and/or the timing mechanism 230 in the gamepiece 100. According to another aspect of the invention, the gamepiece 100 may immediately alert a consumer that the gamepiece 100 is a winner without activating the timing mechanism, or by making the timing mechanism 230 default to, or reprogram to, a small time interval. Furthermore, the gamepiece 100 may operate as described above, such that the timing mechanism 230 and alert provided by the alert mechanism may occur at a ‘random interval’, but may be overridden when a user comes within the vicinity of an RF tag. According to yet another embodiment of the invention, smartcards or other devices may also be used to make the alerts of the gamepieces 100 location-dependent.

Referring once again to FIG. 2, above, once the alert mechanism 235 is activated, it may be only active for a short period of time. Thus, a consumer may be required to turn in the winning gamepiece within that period of time to redeem an award or receive a prize. According to an aspect of the invention, winning gamepieces may be intermingled with visibly similar devices that are inactive and do not include alerts. Thus, a large volume of gamepieces may be handed out in a sweepstakes to entice consumers to stay geographically at the location at which a winning gamepiece is to be redeemed.

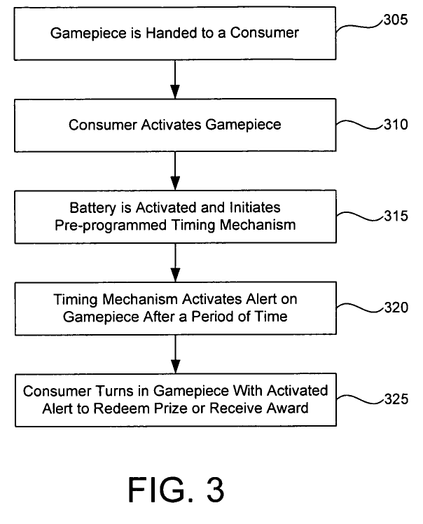

Next, FIG. 3 is a block diagram flow chart illustrating a method of using a gamepiece of the present invention, according to an embodiment of the present invention. After a gamepiece is handed to a consumer (block 305), the consumer may activate the gamepiece (block 310). Upon activation by the consumer, the battery is activated, which initiates a pre-programmed timing mechanism (block 315). After a period of time passes, which may be a predetermined period of time programmed or preset into the timing mechanism, the alert mechanism of the gamepiece is activated (block 320). After the alert mechanism is activated, the consumer may turn in the gamepiece to redeem a prize or to receive an award (block 325).

FIG. 4 is a block diagram flow chart illustrating another method of using a gamepiece of the present invention, according to an embodiment of the present invention. As shown in FIG. 4, a consumer may request a gamepiece (block 405), upon which the gamepiece is activated by an operator of a sweepstakes and handed to a consumer (block 410). Upon activation, which initiates a pre-programmed timing mechanism (block 415). After a period of time passes, which may be a predetermined period of time programmed or preset into the timing mechanism, the alert mechanism of the gamepiece is activated (block 420). After the alert mechanism is activated, the consumer may turn in the gamepiece to redeem a prize or to receive an award (block 425).

According to another embodiment of the present invention, consumers may receive an alert that they are a sweepstakes or contest winner via a message (e.g., a text message) displayed on a wireless gamepiece, such as a wireless PDF, cellular or mobile phone, FM radio, RIM Blackberry™, Microsoft® Smartwatch™, or similar wireless device known to those of ordinary skill in the art. The wireless gamepiece may be given to sweepstakes or contest contestants for the purposes of providing promotional information, including winner alerts. Wireless gamepieces may also be registered with a sponsor of a sweepstakes, drawing, or the like to enable the devices to receive promotional information. Promotional information may be broadcast to all consumers, or only to a specific sweepstakes or contest winner, as described in detail below. Consumers may also receive other messages via the wireless gamepiece, such as personalized information and other content provided via one or more wireless channels.

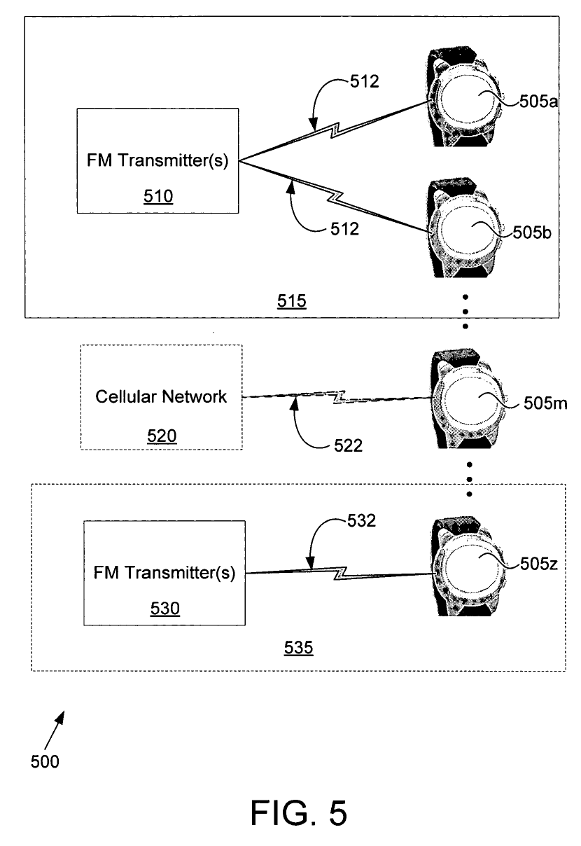

An illustrative example of a messaging system 500 using wireless gamepieces 505a, 505b, . . . , 505m, 505z is shown in FIG. 5. The wireless gamepieces 505a, 505b, . . . , 505m, 505z of FIG. 5 are watches operable to receive information via FM frequencies, and may include a Microsoft® Smartwatch™. A Smartwatch™, as is known in the art, is operable to receive FM broadcasts and to display information (including text and graphics) to a user via a graphical user interface (GUI). According to one aspect of the invention, promotional information may be transmitted to one or more of the devices 505a, 505b, . . . , 505m, 505z. Promotional information may include promotion and/or sweepstakes (and/or contest) details, winner announcements, give-aways, special offers, and the like. According to another aspect of the invention, other information received by the devices 505a, 505b, . . . , 505m, 505z may include news, weather, sports, and the like, which may be accessible via channels the consumer may browse through using one or more GUIs on each device 505a, 505b, . . . , 505m, 505z.

In the system 500, wireless gamepieces 505a, 505b may receive messages only while in the vicinity of an FM broadcast 512 by an FM transmitter 510. Further, according to one aspect of the invention, the FM broadcast may only be received by the devices 505a, 505b while positioned within a sweepstakes area 515. For instance, the wireless gamepieces 505a, 505b may only receive promotional information while within or on the premises of the sponsor of a promotional event, e.g., within a casino which is running a promotion. Devices 505m, 505z outside of the sweepstakes area 515 will be unable to receive the promotion information due to the inability of the devices 505m, 505z to receive the FM broadcast 512. This may result from the signal strength of the FM broadcast 512 transmitted by the FM transmitter(s) 510, which may be limited by the sponsor to ensure that wireless gamepieces outside of the sweepstakes area 515 cannot participate in the sweepstakes and thus do not receive promotional information. Transmitting messages to a local wireless device using a FM broadcast system is well known to those of ordinary skill in the art, and therefore will not be further described herein.

Due to the inability of the devices 505a, 505b, . . . , 505m, 505z to receive promotional information when outside of a sweepstakes area 515, a consumer may wish to remain in the sweepstakes area during a promotional event, which is similar to the incentive provided by the gamepiece 100 described with respect to FIGS. 1-4. However, unlike the timing mechanism of the gamepiece, the system 500 shown in FIG. 5 permits the sponsor of the promotion to control when messages will be sent to the wireless gamepieces 505a, 505b, . . . , 505m, 505z to alert one or more consumers that they are sweepstakes or contest winner, and/or to alert consumers as to other promotional information. Similar to the alerts for the gamepiece 100 described with respect to FIG. 1, the messages sent to consumers may include a time limit for responding to the alert (e.g., for redeeming a prize). This may alert the consumer of a time by which a prize should be redeemed, or alternatively, the alert may last on a device for only a limited period of time in which the consumer must redeem a prize or the like. The messages may also include information useful to the user in responding to the alert, such as instructions on how and where to take a particular action, such as where to redeem a prize.

Promotional information may be transmitted to all wireless gamepieces 505a, 505b, . . . , 505m, 505z via a specific channel accessible by the devices 505a, 505b, . . . , 505m, 505z. Alternatively, promotional information may be specific to a designated device, such as the wireless device held by a randomly selected contest winner. Where promotional information is intended only for a specific wireless device, a unique key may be required to be transmitted that will permit only the intended recipient device to receive the promotional information. For instance, an alert in the form of a winning message may be sent to a specific wireless device that is chosen at random from registered devices. Such an alert may also cause the wireless device to operate in an alert mode, for instance, by beeping, vibrating, lighting up, and/or a combination of the above. Furthermore, the timing for sending the alert may be chosen randomly within a preset period of time, such as 3-5 hours from the beginning of a promotion, the opening of a facility, or the like.

According to another aspect of the invention, it will be appreciated that because the range of the wireless gamepieces 505a, 505b, . . . , 505m, 505z is limited only by the devices' ability to receive an FM signal, devices 505a, 505b, . . . , 505m, 505z may also receive promotional information while in the range of any FM broadcast system. For instance, even if a device 505z is outside of the range outside of the sweepstakes area 515, the device 505z may be able to receive promotional information when the device is within another sweepstakes area 535 in which the device 505z receives an FM broadcast 532 from an FM transmitter 530. Thus, a sweepstakes or promotional event may be held simultaneously at multiple locations that each include respective FM transmitter(s). According to one aspect of the invention, simultaneous FM transmissions may occur at multiple locations to enable a contest, sweepstakes, or promotion simultaneously at a large number of locations. The FM transmission may be linked via a real-time webcast or the like to achieve simultaneous transmission of an FM broadcast. Alternatively, different contests that are location specific may be simultaneously held using the system 500 shown in FIG. 5, where FM broadcasts carry different promotional information based on the location of the FM transmitter(s).

According to another aspect of the invention, the wireless gamepieces 505a, 505b, . . . , 505m, 505z may receive promotion information on a nationwide basis. This may be achieved, for example, where the devices never leave the area of FM broadcasts broadcast from multiple FM transmitters on a large geographic scale. Therefore, although an event sponsor may wish to limit the reception of promotional information to wireless gamepieces within a specific sweepstakes area 515, 535, an event sponsor may alternatively transmit the promotional information to all wireless gamepieces within the range of any FM transmitter operable to broadcast the promotional information, regardless of whether the broadcast is contained within a sweepstakes area.

According to yet another aspect of the invention, multiple communication systems may be used to extend to range of wireless gamepieces 505a, 505b, . . . , 505m, 505z. For instance, as is shown in FIG. 5, a wireless device 505m may be operable to receive promotional information via a cellular network 520 and cellular transmission 522. The ability to receive communication via more than one type of network may effectively extend the range of the wireless gamepieces, which may be desirable where a national contest is desired by an event sponsor. The device 505m may also automatically prioritize the signals it receives, such that the device 505m may provide the user with promotional information transmitted via FM broadcasts 512 when in the vicinity of a sweepstakes area, and provide the user with promotional information received via the cellular network when FM broadcasts are unavailable to the device 505m. Therefore, the devices of the present invention may provide location-relevant promotional information to consumers.

It will be appreciated that the system shown in FIG. 5 is for illustrative purposes only and that alternative communication systems may also be used, such as a Wi-Fi network, cellular communications network, packet radio network, or the like. Additionally, one or more different communication systems may be used in combination. Additional methods of communicating promotional information (e.g., alerts) to consumers carrying different devices may also be employed. For instance, consumers may also receive promotional information via registered cellular phones, for instance, via voicemail messages, telephone calls, or text messages. Furthermore, one or more different devices may be employed simultaneously to provide consumers with multiple methods for receiving alerts.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A gamepiece, comprising:
at least one alert mechanism, wherein the at least one alert mechanism is operable to alert a person associated with the gamepiece; and
a timing mechanism, wherein the timing mechanism is operable to activate the at least one alert mechanism after the passage of a predetermined length of time unknown to the person.

2. The electronic gamepiece of claim 1, further comprising an initiator, operated by the person, wherein the initiator is operable to instruct the timing mechanism to begin operation to determine the passage of the predetermined length of time.

3. The electronic gamepiece of claim 1, further comprising an initiator, operable to receive wireless activation and to instruct the timing mechanism to begin operation to determine the passage of the predetermined length of time.

4. The gamepiece of claim 1, wherein the at least one alert mechanism is selected from the group of alert mechanisms consisting of a light emitting diode (LED), a light, a vibrating mechanism, and a speaker.

5. The gamepiece of claim 1, wherein the timing mechanism comprises a battery.

6. The gamepiece of claim 1, further comprising a battery, and wherein the timing mechanism is coupled to the battery.

7. The gamepiece of claim 6, wherein the at least one alert mechanism is operable to alert a person associated with the gamepiece for a period of time based at least in part on the power remaining in the battery.

8. A method of alerting a person of a contest result, comprising:
activating a timing mechanism of a gamepiece, wherein the timing mechanism is operable to activate at least one alert mechanism of the gamepiece after the passage of a predetermined length of time unknown to the person.

9. The method of claim 8, further comprising activating a battery of the gamepiece.

10. The method of claim 8, wherein activating a timing mechanism comprises wirelessly activating the timing mechanism.

11. The method of claim 8, the timing mechanism is operable to activate at least one alert mechanism selected from the group of alert mechanisms consisting of a light emitting diode (LED), a light, a vibrating mechanism, and a speaker.

12. A promotion system, comprising:
a plurality of wireless gamepieces;
software operable to randomly select at least one winning device from the plurality of registered wireless gamepieces; and
at least one transmitter operable to transmit information to the at least some of the plurality of wireless gamepieces, wherein the information alerts a person associated with the at least one winning device that he or she has won an award or prize.

13. The system of claim 12, wherein the at least one transmitter is a radio frequency (RF) transmitter.

14. The system of claim 12, wherein the plurality of wireless gamepieces are selected from the group of wireless devices consisting of a phone, watch, personal digital assistant, email device, smart card, RF device, and GPS receiver.

15. The system of claim 12, wherein the at least one transmitter is operable to transmit the information only over a short distance, such that the information alerts the person associated with the at least one winning device that he or she has won an award or prize only if the person is within the short distance from the at least one transmitter.

16. A promotion system, comprising:
a plurality of wireless gamepieces;
software operable to randomly select at least one winning device from the plurality of registered wireless gamepieces; and
at least on transmitter operable to transmit information to the at least one winning device to alert a person associated with the at least one winning device that he or she has won an award or prize.

17. The system of claim 16, wherein the at least one transmitter is a radio frequency (RF) transmitter.

18. The system of claim 16, wherein the plurality of wireless gamepieces are selected from the group of wireless devices consisting of a phone, watch, personal digital assistant, email device, smart card, RF device, and GPS receiver.

19. The system of claim 16, wherein the at least one transmitter is operable to transmit the information only over a short distance, such that the information alerts the person associated with the at least one winning device that he or she has won an award or prize only if the person is within the short distance from the at least one transmitter.

20. The system of claim 16, wherein the at least one transmitter is an FM transmitter.
